(19) United States
(12) Patent Application Publication
(10) Pub. No.: US 2024/0338546 A1
(43) Pub. Date: Oct. 10, 2024

(54) SUBSCRIBER IDENTIFICATION MODULE (SIM) CARD ASSEMBLY AND METHOD OF FORMING A SIM CARD

(71) Applicant: ACT IDENTITY TECHNOLOGY LIMITED, Kwai Chung, New Territories (HK)

(72) Inventor: Gang Chen, Kwai Chung, New Territories (HK)

(21) Appl. No.: 18/579,990

(22) PCT Filed: Jul. 28, 2022
(86) PCT No.: PCT/CN2022/108515

§ 371 Date: Jan. 17, 2024

Related U.S. Application Data
(60) Provisional application No. 63/228,231, filed on Aug. 2, 2021.

(51) Int. Cl. G06K 19/077

(52) U.S. Cl. CPC G06K 19/07722

(57) ABSTRACT

A subscriber identification module (SIM) card assembly (100, 200, 300) is disclosed as including a multi-layered body (102, 202, 302) and a plurality of SIM cards (104, 204, 304) fixedly connected with the body, each SIM card including an integrated-circuit (IC) chip (106), and the body including at least a layer of glass-reinforced epoxy laminate material (122, 126, 142). A method of forming a SIM card (104, 204, 304) is also disclosed.

### FIELD OF THE INVENTION

This invention relates to a subscriber identification module (SIM) card assembly, and a method of forming SIM cards.

### BACKGROUND OF THE INVENTION

In a prior art method of forming a subscriber identification module (SIM) card (generally designated as 10) as shown in FIGS. 1 and 2, a stepped-wise cavity 12 is formed in a plastic card body 14. A common plastic material for forming the card body 14 is acrylonitrile butadiene styrene (ABS) or polyvinyl chloride (PVC). It requires at least two steps to form each such stepped-wise cavity 12, firstly forming a narrower yet deeper trough, then forming a wider but shallower trough communicating with the first trough. An integrated-circuit (IC) chip module 16 is then engaged with one or more hot-melt tapes 18. The IC chip module 16 is placed in the cavity 12 with the hot-melt tapes 18 attached to a stepped portion 20 of the cavity 12. The IC chip module 16 is then fixedly engaged with the body 14 by lamination, whereby the hot-melt tapes 18 melt to fixedly engage the IC chip module 16 with the body 14.

Such a method and the SIM card 10 formed by such a method suffer from a number of disadvantages. Firstly, there is the risk of de-lamination of the melted hot-melt tapes 18, thus compromising the attachment between the IC chip module 16 and the body 14. Secondly, there is a gap 22 in the cavity 12 between the IC chip module 16 and the body 14, which may affect the structural integrity of the SIM card 10, in particular after repeated use. Thirdly, the production method is relatively complicated as it requires at least two steps to form the cavity 12. Fourthly, the Vicat softening temperature is relatively low, at around 90° C. if ABS is used, or at around 78° C. if PVC is used.

It is thus an object of the present invention to provide a subscriber identification module (SIM) card assembly and a method of forming a SIM card in which the aforesaid shortcomings are mitigated, or at least to provide a useful alternative to the trade and public.

### SUMMARY OF THE INVENTION

According to a first aspect of the present invention, there is provided a subscriber identification module (SIM) card assembly including a multi-layered body, and a plurality of SIM cards fixedly connected with said body, wherein each said SIM card includes an integrated-circuit (IC) chip, and wherein said body includes at least a layer of glass-reinforced epoxy laminate material.

According to a second aspect of the present invention, there is provided method of forming a subscriber identification module (SIM) card, including providing a length of multi-layered body with a plurality of cavities each sized and configured to receive at least a part of an integrated-circuit (IC) chip, positioning a respective IC chip in each of said plurality of cavities, securing at least one said IC chip with said cavity in which at least a part of said IC chip is positioned, and separating at least one SIM card from said body.

### BRIEF DESCRIPTION OF THE DRAWINGS

Embodiments of the present invention will now be described, by way of examples only, with reference to the accompanying drawings, in which:

FIG. 1 is a schematic sectional view of a prior art subscriber identification module (SIM) card;

FIG. 2 is a schematic exploded sectional view of the prior art SIM card of FIG. 1;

FIG. 3A is a front view of a subscriber identification module (SIM) card assembly according to a first embodiment of the present invention;

FIG. 3B is a rear view of the SIM card assembly of FIG. 3A;

FIG. 4A is a schematic sectional view of the length of the SIM card assembly of FIG. 3A of a first exemplary structure;

FIG. 4B is a schematic sectional view of the length of the SIM card assembly of FIG. 3A of a second exemplary structure;

FIG. 5 is a front view of a subscriber identification module (SIM) card assembly according to a second embodiment of the present invention;

FIG. 6 is a front view of a subscriber identification module (SIM) card assembly according to a third embodiment of the present invention;

FIGS. 7 to 10 show steps of forming a SIM card according to an embodiment of the present invention;

FIG. 11A is a front perspective view of a SIM card formed according to the method of the present invention; and

FIG. 11B is a rear perspective view of the SIM card of FIG. 11A.

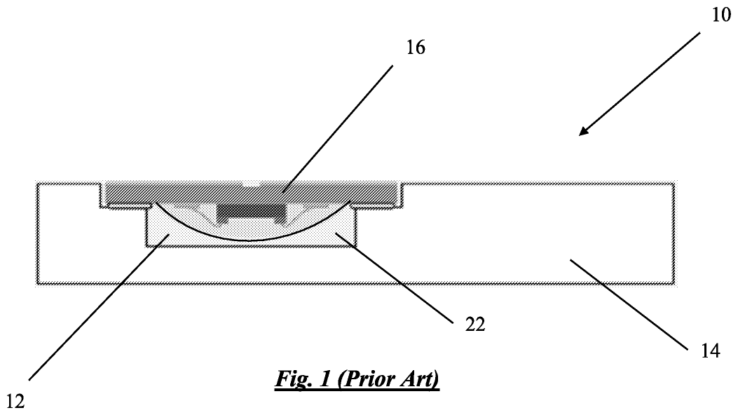

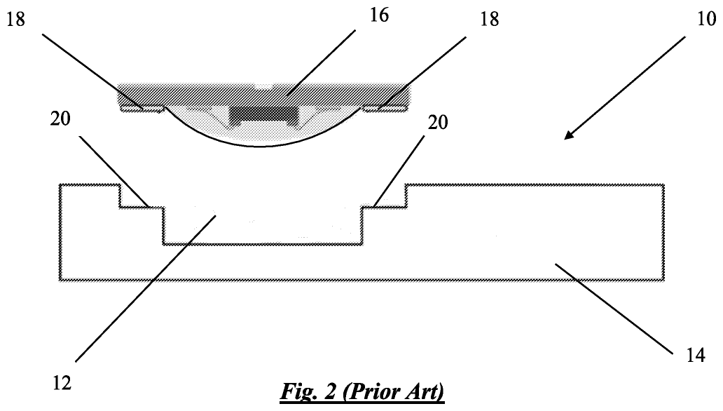

### DESCRIPTION OF THE EMBODIMENTS

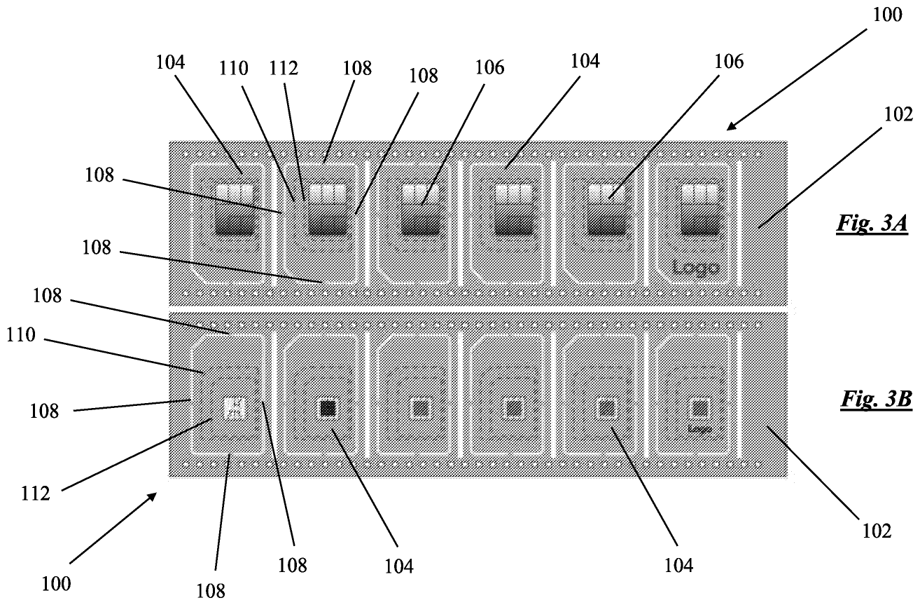

FIGS. 3A and 3B are, respectively, a front view and a rear view of a subscriber identification module (SIM) card assembly according to an embodiment of the present invention, generally designated as 100.

The SIM card assembly 100 is in the form of an elongate length of multi-layered substrate, which may be in a reel form when wound upon itself, or in the form of a panel. The card assembly 100 has a multi-layered body 102 to which a plurality of SIM cards 104 are fixedly attached. Each SIM card 104 includes an integrated-circuit (IC) chip 106.

Each SIM card 104 is fixedly connected with the body 102 by a number of narrow connecting bridges 108. As one example, FIGS. 3A and 3B show that each SIM card 104 is fixedly connected with the body 102 by four narrow connecting bridges 108. If the SIM cards 104 are separated from the SIM card assembly 100 by breaking the connecting bridges 108 (e.g. by laser cutting, punching, by die-cutting or by hand), the resultant SIM cards 104 are of a 2FF form factor, i.e. of a length of 25 mm, a width of 15 mm and a thickness of around 0.62 mm to 0.76 mm, e.g. 0.68 mm.

Arranged around and closer to IC chip 106 is a first set of cut-out lines 110. The distance between the first set of cut-out lines 110 and the IC chip 106 is shorter than that between the connecting bridges 108 and the IC chip 106. If the SIM cards 104 are separated from the SIM card assembly 100 by breaking the first set of cut-out lines 110 (e.g. by laser cutting, punching, by die-cutting or by hand), the resultant SIM cards 104 are of a 3FF form factor, i.e. of a length of 15 mm, a width of 12 mm and a thickness of around 0.62 mm to 0.76 mm, e.g. 0.68 mm, which are of a smaller size than the SIM cards 104 of a 2FF form factor.

Arranged around and still closer to IC chip 106 is a second set of cut-out lines 112. The distance between the second set of cut-out lines 112 and the IC chip 106 is shorter than that between the first set of cut-out lines 110 and the IC chip 106. If the SIM cards 104 are separated from the SIM card assembly 100 by breaking the second set of cut-out lines 112 (e.g. by laser cutting punching, by die-cutting or by hand), the resultant SIM cards 104 are of a 4FF form factor, i.e. of a length of 12.3 mm, a width of 8.8 mm and a thickness of around 0.62 mm to 0.76 mm, e.g. 0.68 mm, which are of a smaller size than the SIM cards 104 of a 3FF form factor.

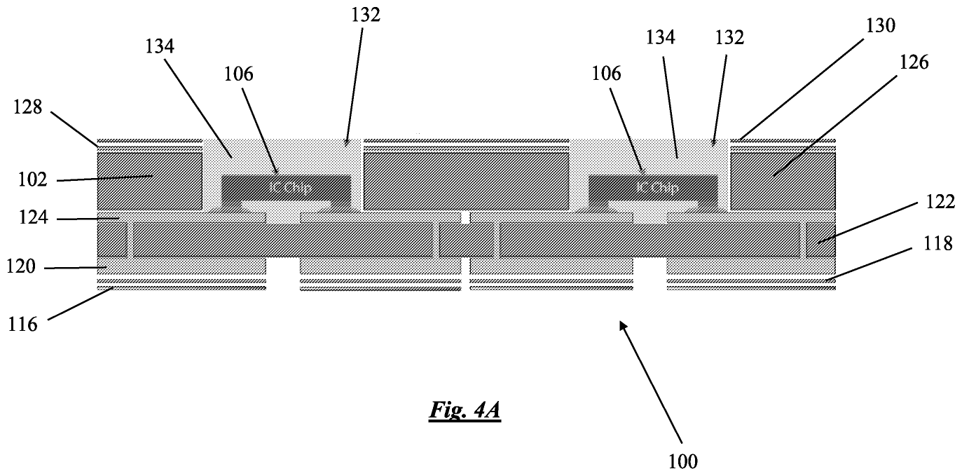

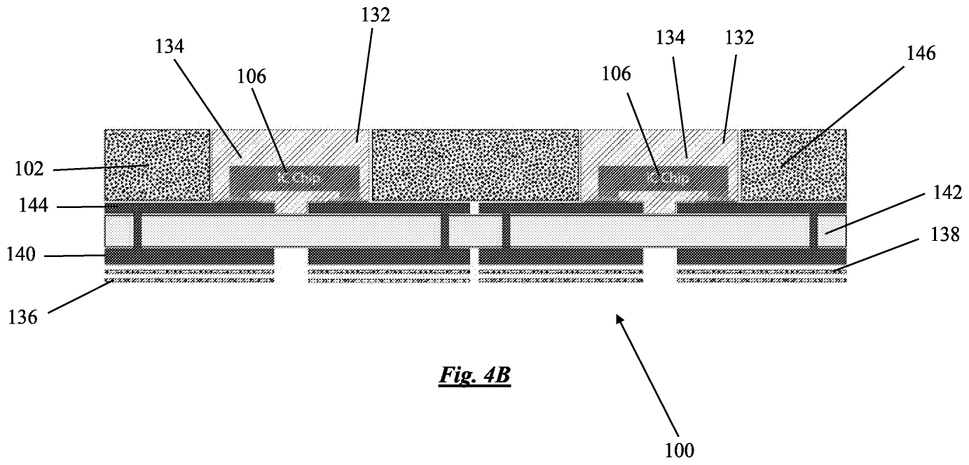

A schematic sectional view of the length of the SIM card assembly 100 shown in FIGS. 3A and 3B of a first exemplary structure is shown in FIG. 4A. The SIM card assembly 100 is of a multi-layered structure with the body 102 of a total thickness of 0.680 mm. As shown in FIG. 4A, the body 102 (which is of a multi-layered structure) includes (counting upward from the bottom layer) a gold (Au) layer 116 of, e.g. 0.005 mm, a nickel (Ni) layer 118 of, e.g. 0.005 mm, a copper (Cu) layer 120 of, e.g. 0.050 mm, an FR4 layer 122 of, e.g. 0.200 mm, a copper (Cu) layer 124 of, e.g. 0.010 mm, an FR4 layer 126 of, e.g. 0.400 mm, a copper (Cu) layer 128 of, e.g. 0.005 mm, and a nickel (Ni) layer 130 of, e.g. 0.005 mm. Not all of these layers are essential for forming the SIM card assembly 100. For example, the bottom gold layer 116 may be absent. The thickness of each layer of the SIM card assembly 100 is also not essential to be the same as those mentioned above, and the total thickness may not be 0.680 mm. For example, the total thickness of the SIM card assembly 100 may be 0.760 mm.

“FR4” (or “FR-4”) is a National Electrical Manufacturers Association (NEMA) designation for a glass-reinforced epoxy laminate flame retardant material, which is a composite material composed of woven fiberglass cloth with an epoxy resin binder that is flame retardant.

Along the length of the body 102 of the SIM card assembly 100 are a number of cavities 132 each sized and configured to receive a respective IC chip 106. Each IC chip 106 is received within a respective cavity 132 of the body 102 of the SIM card assembly 100 and the IC chip 106 is secured with the body 102 of the SIM card assembly 100.

A schematic sectional view of the length of the STM card assembly 100 shown in FIGS. 3A and 3B of a second exemplary structure is shown in FIG. 4B. The SIM card assembly 100 is of a multi-layered structure with the body 102 of a total thickness of 0.680 mm. As shown in FIG. 4B, the body 102 (which is of a multi-layered structure) includes (counting upward from the bottom layer) a gold (Au) layer 136 of, e.g. 0.005 mm, a nickel (Ni) layer 138 of, e.g. 0.005 mm, a copper (Cu) layer 140 of, e.g. 0.050 mm, an FR4 layer 142 of, e.g. 0.200 mm, a copper (Cu) layer 144 of, e.g. 0.010 mm, and a plastic layer 146 of, e.g. 0.410 mm. The plastic layer 146 may be made of acrylonitrile butadiene styrene (ABS) or polyvinyl chloride (PVC). Again, not all of these layers are essential for forming the SIM card assembly 100. For example, the bottom gold layer 136 may be absent.

Along the length of the body 102 of the SIM card assembly 100 and through the plastic layer 146 are a number of cavities 132 each sized and configured to receive a respective IC chip 106. Each IC chip 106 is received within a respective cavity 132 of the body 102 of the SIM card assembly 100 and the IC chip 106 is secured with the body 102 of the SIM card assembly 100.

FIG. 5 shows a front view of a subscriber identification module (SIM) card assembly according to another embodiment of the present invention, generally designated as 200. A main difference between the SIM card assembly 200 shown in FIG. 5 and the SIM card assembly 100 shown in FIGS. 3A and 3B is that, in the SIM card assembly 200 shown in FIG. 5 there are no cut-out lines within a plurality of connecting bridges 208 of the 2FF SIM cards 204, which means that it is only possible to form SIM cards 204 of one size (namely, 2FF) from the SIM card assembly 200.

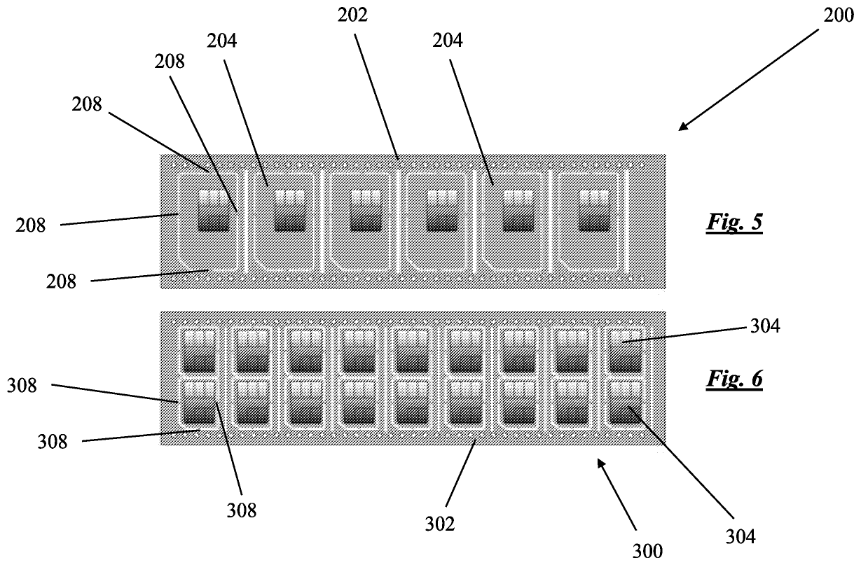

FIG. 6 shows a front view of a subscriber identification module (SIM) card assembly according to a further embodiment of the present invention, generally designated as 300. There are two main differences between the SIM card assembly 300 shown in FIG. 6 and the SIM card assembly 100 shown in FIGS. 3A and 3B. Firstly, in the SIM card assembly 300 shown in FIG. 6, if SIM cards 304 are separated out from the multi-layered body 302 of the assembly 300 by breaking several narrow bridges 308, the SIM cards 304 are of a form factor of 4FF. Secondly, because of the smaller size of 4FF STM cards 304 as compared with 2FF STM cards 204 (e.g. as shown in FIG. 5), two rows of SIM cards 304 may be arranged in matrix form along the length of the SIM card assembly 300 of FIG. 6.

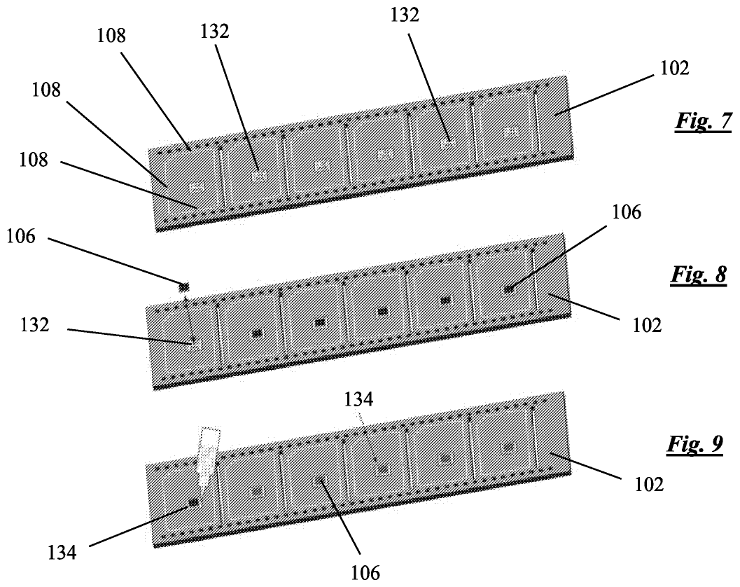

FIG. 7 shows schematically a multi-layered body 102 of the SIM card assembly 100, in which a series of 2FF sized and shaped portions are formed along the length of the multi-layered body 102, each of which 2FF sized and shaped portions being connected with the multi-layered body 102 by a number of (e.g. four) narrow connecting bridges 108. Within each of the portions is a cavity 132 sized and configured to receive a respective IC chip 106.

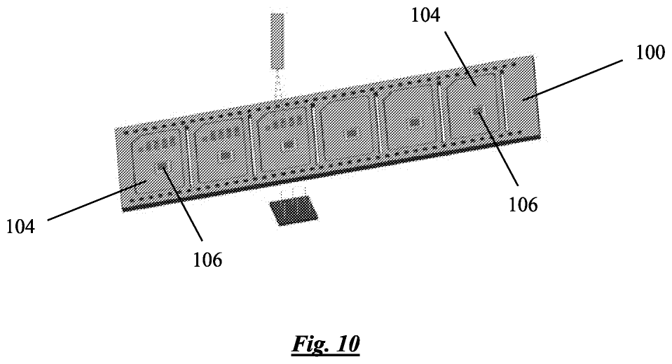

As schematically shown in FIG. 8, an IC chip 106 is flipped and secured with the copper layer 124 at the bottom of the cavity 132 by a conductive material (such as conductive adhesive or a conductive paste) or by a wire-bonding method. Then, and as shown schematically in FIG. 9, glue 134 is filled in the IC-chip-containing cavity 132 to encapsulate and protect the IC chip 106 within the cavity 132. It can be seen from FIG. 4A that, in the SIM card assembly 100, the IC chip 106 is received wholly received the cavity 132, and that the glue 134 fills up all the remaining space in the cavity 132 not occupied by the IC chip 106, up to the nickel layer 130 at the top of the assembly 100. In the SIM card assembly 100 shown in FIG. 4B, the IC chip 106 is received wholly received the cavity 132, and the glue 134 fills up all the remaining space in the cavity 132 not occupied by the IC chip 106, up to the top of the plastic layer 146 at the top of the assembly 100.

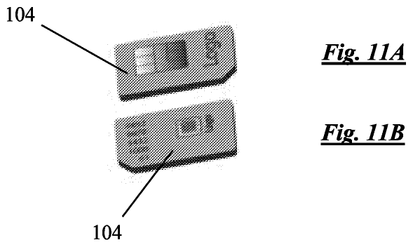

As shown schematically in FIG. 10, the SIM cards 104 of the SIM card assembly 100 then undergo personalization by printing (e.g. by laser engraving) Integrated Circuit Card ID (ICCID) number on a surface of the SIM cards 104 and writing appropriate data into the IC chips 106 of the SIM cards 104. Finally, the plurality of SIM cards 104 are separated out from the body 102 of the SIM card assembly 100 (e.g. by hand, by punching or by die-cutting) as separate personalized SIM cards 104, as shown in FIGS. 11A and 11B.

As compared with the prior art method and SIM cards formed by the prior art method, it can be seen that the present invention possesses the following advantages. Firstly, as no hot-melt tape is used, there is no risk of de-lamination of the melted hot-melt tape which compromises the attachment between the IC chip 106 and the body 102, 202, 302. Secondly, as the space in the cavity 132 between the IC chip 106 and the body 102, 202 302 is filled up by the glue 134, the structural integrity of the SIM card 104, 204, 304 is enhanced. Thirdly, formation of the cavities 132 requires one step (e.g. by milling) only. Fourthly, as FR4 is used, the Vicat softening temperature can be raised to around 135° C.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A subscriber identification module (SIM) card assembly including: a multi-layered body, and a plurality of SIM cards fixedly connected with said body, wherein each said SIM card includes an integrated-circuit (IC) chip, and wherein said body includes at least a layer of glass-reinforced epoxy laminate material.

2. The assembly of claim 1, wherein said body includes at least two layers of glass-reinforced epoxy laminate material.

3. The assembly of claim 1, wherein said body includes at least one layer of glass-reinforced epoxy laminate material and at least one plastic layer.

4. The assembly of claim 3, wherein said plastic layer is made of acrylonitrile butadiene styrene (ABS) or polyvinyl chloride (PVC).

5. The assembly of claim 1, wherein said layer of glass-reinforced epoxy laminate material is a composite material including woven fiberglass cloth with a flame-resistant epoxy resin binder.

6. The assembly of claim 1, wherein said assembly is in reel form or in the form of a panel.

7. The assembly of claim 1, wherein said plurality of SIM cards are arranged in matrix form along a length of said body.

8. The assembly of claim 1, wherein each said SIM card is connected with said body by a plurality of connecting bridges.

9. The assembly of claim 1, further including at least a first set of cut-out lines around said IC chip, wherein the distance between said first set of cut-out lines and said IC chip is shorter than the distance between said plurality of connecting bridges and said IC chip.

10. The assembly of claim 9, wherein a SIM card of a first size is separable from said body by breaking said plurality of connecting bridges.

11. The assembly of claim 10, wherein a SIM card of a second size is separable from said body by breaking said first set of cut-out lines, and wherein said second size is smaller than said first size.

12. The assembly of claim 11, further including at least a second set of cut-out lines around said IC chip, wherein the distance between said second set of cut-out lines and said IC chip is shorter than the distance between said first set of cut-out lines and said IC chip.

13. The assembly of claim 12, wherein a SIM card of a third size is separable from said body by breaking said second set of cut-out lines, and wherein said third size is smaller than said second size.

14. A method of forming a subscriber identification module (SIM) card, including:
providing a length of multi-layered body with a plurality of cavities each sized and configured to receive at least a part of an integrated-circuit (IC) chip, said multi-layered body including at least a layer of glass-reinforced epoxy laminate material,
positioning a respective IC chip in each of said plurality of cavities,
securing at least one said IC chip with said cavity in which at least a part of said IC chip is positioned, and
separating at least one SIM card from said body.

15. The method of claim 14, wherein said step of securing at least one said IC chip with said cavity in which at least a part of said IC chip is positioned includes filling at least a part of said cavity with at least one conductive material.

16. The method of claim 15, wherein said conductive material is a conductive adhesive or a conductive paste.

17. The method of claim 14, wherein said step of securing at least one said IC with said cavity in which at least a part of said IC chip is positioned includes wire-bonding said IC chip with said body.

18. The method of claim 14, further including filling at least part of said cavity with a glue to encapsulate said IC chip.

19. (canceled)

20. The method of claim 14, wherein said layer of glass-reinforced epoxy laminate material is a composite material including woven fiberglass cloth with a flame-resistant epoxy resin binder.

21. The method of claim 14, wherein said body is in reel form or in the form of a panel.

22. The method of claim 14, wherein said plurality of cavities are arranged along a length of said body in matrix form.

23. The method of claim 14, wherein said step of separating at least one SIM card from said body includes separating at least one SIM card of a first size from said body by breaking a plurality of connecting bridges connecting said SIM card of said first size with said body.

24. The method of claim 23, wherein said step of separating at least one SIM card from said body includes separating at least one SIM card of a second size from said body by breaking at least a first set of cut-out lines, and wherein said first size is larger than said second size.

25. The method of claim 24, wherein said step of separating at least one SIM card from said body includes separating at least one SIM card of a third size from said body by breaking at least a second set of cut-out lines, and wherein said second size is larger than said third size.
